(19) United States
(12) Patent Application Publication
(10) Pub. No.: US 2009/0035739 A1
(43) Pub. Date: Feb. 5, 2009

(54) DENTAL SIMULATOR

(75) Inventor: Kazem Alemzadeh, Bristol (GB)

Correspondence Address: MARSHALL, GERSTEIN & BORUN LLP, 233 S. WACKER DRIVE, SUITE 6300, SEARS TOWER, CHICAGO, IL, 60606, US

(73) Assignee: THE UNIVERSITY OF BRISTOL, Bristol (GB)

(21) Appl. No.: 11/830,579

(22) Filed: Jul. 30, 2007

(51) Int. Cl. A61C 11/00

(52) U.S. Cl. 434/264

(57) ABSTRACT

Dental simulation apparatus comprising a six degrees of freedom motion actuator having an upper mobile portion; an artificial mandible secured to the mobile portion of the motion actuator, the artificial mandible being arranged to receive a plurality of artificial teeth or other dental restoratives; and an artificial maxilla rigidly located about the artificial mandible, the artificial maxilla also being arranged to receive a plurality of artificial teeth or other dental restoratives.

### BACKGROUND TO THE INVENTION

The market for dental restorations is already commercially significant and is only likely to grow over the coining years as the public becomes more aware of the advances is aesthetic materials and dental implants as these become more affordable and readily available. For example, there are constant advances in the use of oxide and silicate ceramics that are currently used in restorative dentistry for inlays, onlays, crowns or bridges. However, despite the frequent use of such ceramics and other composites in dentistry their physical parameters, such as their modulus of elasticity, flexural strength, material hardness and their interactions with respect to wear and fatigue are often poorly understood.

Human mastication and associated repetitive dental loading have been proved to dramatically reduce the strength of dental components and restorative materials, especially ceramic restorations which tend to be brittle and have low tensile strength. This coupled with micro-cracking and frictional sliding during cyclical loading increases the risk of failure of the dental restorations. Therefore it is important to understand the mechanical properties of the materials used, such as their wear performance, to predict the likely life time of such dental restorations. However, medical and clinical trials are generally time consuming, with typical time spans of two to three years, and consequently expensive. It is therefore attractive to the dental restorative manufacturers to develop or make use of apparatus and methods for accelerated screening of the clinical wear at relatively low cost under controlled reproducible laboratory conditions.

Currently the most accurate testing methods take the form of a biaxial testing rig based around a design first developed in 1983 specifically for testing dental restorations. These test rigs can subject a single sample (such as a individual ceramic crown) to the three main types of jaw movement experienced, i.e. preparatory, crushing and gliding movements, and simulate the forces applied while doing so. However, a limitation of these methods is that the human masticatory cycle is an inherently triaxial process, whilst the testing rigs operate biaxially and thus deliver only an approximation to the type of wear experienced. Other mastication simulators have been proposed that more fully simulate the possible motion of the human jaw and achieve this by locating a plurality of mechanical actuators within the space defined by an artificial jaw. The space limitatiaons imposed by this arrangement limits the size of the actuators that can be used and thus limits the maximum force that may be applied to the artificial jaw and dental restorative accordingly.

### SUMMARY OF THE INVENTION

The invention comprises a dental simulation apparatus comprising a six degrees of freedom motion actuator having an upper mobile portion, an artificial mandible secured to the mobile portion of the motion actuator, the artificial mandible being arranged to receive a plurality of artificial teeth or other dental restoratives, and an artificial maxilla rigidly located about the artificial mandible, the artificial maxilla also being arranged to receive a plurality of artificial teeth or other dental restoratives.

A compliance module may be located between the artificial mandible and the mobile portion of the motion actuator, the compliance module including at least one compressible portion arranged such that compression of the compressible portion results in a decrease in the separation of the artificial mandible and the mobile portion of the motion actuator. The compressible portion of the compliance module may be arranged to be compressed only when a force in excess of a first threshold value is applied. The compliance module may include an upper plate connected to the artificial mandible and a lower plate connected to the mobile portion of the motion actuator, the upper and lower plates being spaced apart by at least one compressive spring mounted there-between.

A force sensor may be located between the artificial mandible and the mobile portion of the motion actuator, the force sensor being arranged to measure the compressive force applied to the artificial mandible. The force sensor may also measure lateral forces applied to the artificial mandible.

The motion actuator may include a static portion and a plurality of linear actuators connected between the static and upper mobile portions. The apparatus may further include a control module arranged to control the position, speed and applied force of the linear actuators. Each linear actuator may include a position encoder and may be arranged to provide one or more encoder signals to the control module indicative of the position of the linear actuator, wherein the control module can process the encoder signals so as to provide closed loop control of the linear actuators. The control module may be further arranged to receive one or more signals indicative of the force applied by the actuators.

The apparatus preferably includes a plurality of artificial teeth arranged to be located in either the artificial mandible or maxilla, each tooth having a root comprising a profiled upper root portion and a locating pin. The profile of each upper root portion is different from the remaining teeth and the artificial mandible and maxilla includes a plurality of root receiving cavities, each root receiving cavity having a profiled section having a profile that is complementary to only one of the upper root portions, such that each tooth may only be located in a single cavity. Each upper root portion may have an upper planar surface for a dental crown to be secured to. The length of the upper root portions preferably varies from tooth to tooth such that when each tooth is located in the corresponding cavity of the artificial mandible or maxilla, the upper surfaces of the upper root portions define a Curve of Spee. The upper root portion may include an outer layer of resilient material. Additionally, the root may include a layer of resilient material interposed between the upper root portion and the locating pin. The locating pin may have a rounded end.

### BRIEF DESCRIPTION OF THE DRAWINGS

FIG. 1 schematically illustrates the overall structure of a dental simulator according to an embodiment of the present invention;

FIG. 2 schematically illustrates the control elements provided in embodiments of the present invention for controlling the telescopic actuators;

FIG. 3 illustrates the approximate location of a compressive force sensor within the apparatus of embodiments of the present invention;

FIG. 4 illustrates an individual root portion of the artificial teeth used in embodiments of the present invention;

FIG. 5 schematically illustrates a set of teeth roots of the kind illustrated in FIG. 4 with varying heights defining a curve of spee; and

FIG. 6 schematically illustrates the arrangement of a tooth root within an artificial jaw according to further embodiments of the present invention.

### DETAILED DESCRIPTION OF THE EMBODIMENTS OF THE PRESENT INVENTION

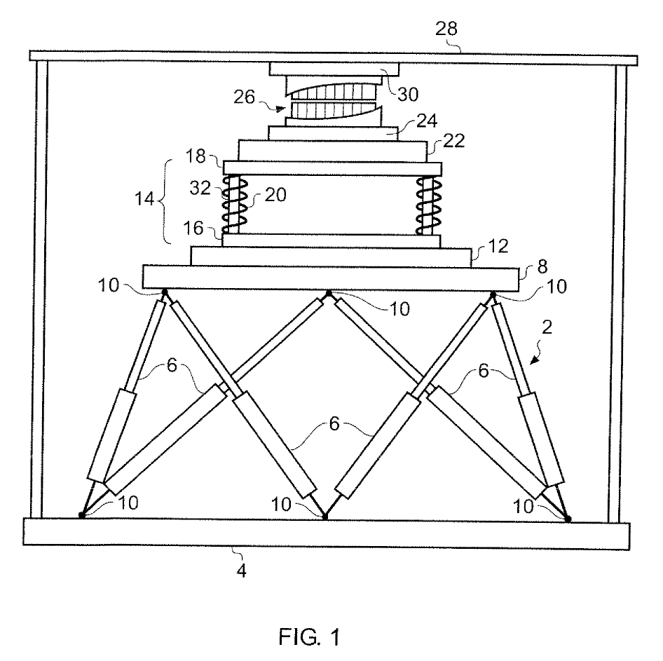

Referring to FIG. 1, the simulator comprises a Stewart platform having a fixed base plate 4, six telescopic actuators 6 and a mobile upper plate 8. In a manner known to those in the art the telescopic actuators 6 are pivotally connected at their opposite ends to the base plate and mobile upper plate, there being three attachment points 10 on each of the base plate and mobile upper plate to which respective pairs of the telescopic actuators are connected. As a consequence of this known arrangement the mobile upper plate 8 has six degrees of freedom, namely both rotation and translation about the X, Y and Z axes. Other 6-DOF actuator platforms, known generically as hexapods, may be used in place of the illustrated Steward platform. Secured to the mobile upper plate is an adaptor plate 12, to which is secured a compliance module 14. The compliance module comprises lower and upper plates 16, 18 that are separated vertically by a series of springs 20 or other resilient structures that allow relative movement between the upper and lower plates of the compliance module in the nominal vertical direction. Fastened to the upper plate of the compliance module is a force transducer and sensor plate 22 to which an artificial lower jaw 24 (mandible) is secured. The artificial mandible is designed so as to receive one or more artificial teeth 26 or other dental restoratives. Consequently, the six degrees of freedom provided by the mobile upper plate 8 of the Stewart platform can be directly conveyed to the artificial mandible 24 and teeth located therein. Located directly above the mandible 24, and rigidly attached to an upper support plate 28, is an artificial upper jaw (maxilla) 30 that in an identical fashion to the mandible 24 is also arranged to receive one or more dental restoratives. The upper support plate 28 is rigidly secured to the main base plate 4 such that the maxilla and the dental restoratives received therein are held stationery with respect to the upper mobile plate of the Stewart platform, and as a result the mandible 24, thus allowing realistic simulated human mastication to be achieved.

When chewing, a combination of both force and position control is required. The human masticatory system achieves this through a combination of neural control and inherent dynamics emergent from the characteristics of muscle and their geometric information. The human muscle structure of the jaw area can alter the inherent stiffness of the jaw and can do so very rapidly. It is this property, for example, that prevents damage to the teeth and jaw when a hard piece of food suddenly gives way. In embodiments of the present invention force and position control are achieved by appropriate control of the six telescopic actuators 6 of the Stewart platform, together, in the illustrated embodiment, with the use of the compliance module 14 to control contact forces. The compliance module allows the simulator to sustain the high bite forces that occur in the contact areas between the upper and lower teeth during normal chewing that are the main causes of dental component failure. Typical chewing forces experienced in the jaw arrange from approximately 9 to 180N. However, for failure testing this force can be as high as 2500N. As noted with reference to FIG. 1, the compliant module comprises an upper and lower plate spaced apart by a plurality of spring mechanisms 20. In the embodiment illustrated, the spring mechanisms comprise a compression spring coaxially mounted around a guide shaft 32 that is fixed relative to either the upper or lower compliance plate with the respective other compliance plate being arranged to be movable with respect to the guide shaft, for example by having either an aperture or recess through which or into which an end of the guide shaft 32 can be received. The number of individual spring assemblies 20 provided within the compliance module may vary but may number for example 6. In preferred embodiments the spring assemblies are arranged such that they only compress when subjected to an axial force above approximately 250N. The compliance module can sustain a maximum force of, for example, 575N, at which force the individual springs have been compressed to their maximum extent. The compliance module therefore allows the direct transmission of normal chewing forces of a magnitude below 250N but also provides a degree of compliance when subject to forces in the range of 250-575N, thus simulating the muscle behaviour in the human jaw. However, forces above 575N may also be directly transmitted to the upper and lower jaws of the simulator to allow complete failure modes of the dental restoratives to be fully simulated and investigated.

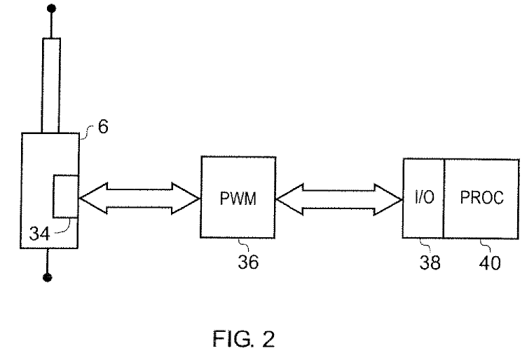

As previously noted the position of and force applied to the artificial mandible via the mobile upper plate of the Stewart platform is primarily controlled by the operation of the telescopic actuators 6. FIG. 2 schematically illustrates the control apparatus according to an embodiment of the present invention. Each telescopic actuator 6 is provided with an electric DC motor 34 that incorporates an hall effect position encoder. Control of each motor is provided using a pulse-width modulation (PWM) module 36 that is arranged to provide a pulse-width modulation voltage to each of the actuator motors to also receive feedback signals from each of the hall effect encoders and also motor current feedback signals from each of the motors. A suitable design and configuration of the PWM module 36 will be known to those skilled in the art and is therefore not discussed in detail here. The feedback signals received by the PWM module 36 from the actuator motor 34 are communicated via an input/output interface 38 to a data processor 40. The data processor 40 calculates the required control signals to be transmitted to the PWM module 36 and thus to the actuator control motors 34 in response to the position, speed and torque readings derivable from the hall effect encoder signals and the motor current signals. When in operation, the length of each individual telescopic actuator 6 is obtained from its respective hall effect encoder. From the rate of change of length the speed of the individual actuators is thus derivable. The average motor current sensed by the PWM module 36 is also provided and with the position and speed data a measure of the force being applied by the actuator is also derivable. The value of the desired length and force of each actuator as calculated by the data processor 40 is compared with the measured value (received at the data processor) and a closed feedback loop is provided using, for example, proportional plus integral and derivative (PID) control. A typical duty cycle provided by the pulse width modulation module 36 is variable between 10% and 100%, giving a wide range of speed control. The PWM module 36 also provides known features such as supply current limiting, motor soft-start and motor current limiting facilities.

Each actuator motor 36 is therefore controlled using an inner-loop current controller and an outer-loop position controller. Additional force measurements from a load cell suitably located on the simulator may also be used by the control apparatus indicated in FIG. 2 in certain embodiments of the present invention. The data processor 40 determines the required position and force control signals so as to closely emulate the behaviour of human muscle as possible. So, for example, the control algorithm allows the chewing motion to slow when chewing resistance is high and to speed it up when there is less resistance. By appropriate software control of the data processor 40, together with suitable position, speed and force encoders and measurement, a level of control and responsiveness of the actuators may be achieved in embodiments of the present invention such that the compliance module 14 illustrated in FIG. 1 and referred to above is not required, the actuator control providing the required degree of compliance.

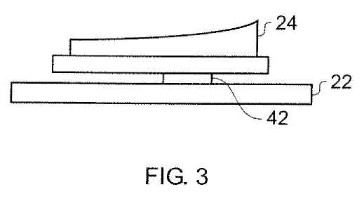

In some embodiments of the present invention one or more strain gauge load cells 42 may be provided located between the lower mandible 24 and the sensor plate 22, as indicated in FIG. 3. During simulated chewing, axial compression forces are thus sensed by the sensor 42 in the crushing and grinding phase of the chewing cycle. Sensor signals representative of these axial compressive forces are also provided as inputs to the data processor 40 illustrated in FIG. 2 to further enhance the control of the telescopic actuators 6 of the Stewart platform. To sense the lateral forces due to, for example, friction or tooth fracture during chewing either further lateral force sensors may be located between the lower mandible 24 and sensor plates 22 or a single set of sensors providing having two orthogonal sensing axes.

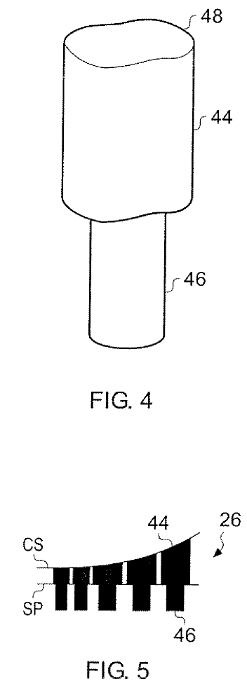

The teeth of the dental simulator comprise a root portion and a crown portion. FIG. 4 illustrates the root portion of one of the teeth and comprises an upper root 44 and a lower locating pin 46. In embodiments of the present invention the upper root 44 of each tooth has a unique profile that exactly matches the corresponding cavity on the respective maxilla or mandible. This means that each root is correctly positioned when placed in its respective jaw, both in terms of the correct tooth being placed in the correct jaw cavity and also each tooth being correctly orientated with respect to the jaw. In other words, each tooth can then placed in a single cavity and in a single orientation with respect to the cavity. The lower locating pin 46 is preferably cylindrical. The upper root 44 has a flat upper surface 48 to which the respective crown, or other dental restoration, is bonded using an appropriate known adhesive or dental cement. The angle of the upper surface 48 with respect to the longitudinal axis of the upper root 44 is different for each tooth in order to ensure correct orientation and positioning of the crown.

The length of each upper root portion 44 varies from tooth to tooth. This variation in height is required to ensure that when the completed the teeth are assembled the crowns of the teeth with occlude. Occlusion in dentistry relates to the way upper maxilla and lower mandible meet during mastication. As the teeth are clenched the upper and lower sets should come together evenly. One factor in achieving good occlusion is to accurately reproduce the “curve of spee” for the maxilla and mandible set of teeth. The curve of spee relate to the natural curvature of the mandibular and maxillary arches, with the curve of spee for the maxilla being convex and for the mandible being concave. Whilst the exact shape of the curve of spee varies from individual to individual, it can generally be defined as “the atomic curve established by the aclusal alignment of the teeth, as projected on the minimum plane, beginning the cusp tip of the mandibular canine and following the buccal cusp tips of the premolar and molar teeth”. In practice, the curve can be made by drawing a straight line between the mesiolingual cusp of the second molar and the buccal cusp of the canine. From there, lines normal to the cusp tips of the premolars, the first molar and second molar, can be drawn. The longest of these distances represents the depth of the curve of spee. Based on these measurements, the radius r of the curve can be calculated by applying standard geometry where s is the distance between the mesiolingual cusp of the second molar tooth and buccal cusp of the canine tooth. The depth of the curve h is thus given by the following formula:

r[h²+(s/2)²]/2h

In embodiments of the present invention this curve is reproduced by adjusting the lengths of the upper root portions 44 for each individual tooth. This is indicated in FIG. 5 where a number of individual teeth 26 are schematically illustrated, each having a uniform lower locating pin length 46 and individual varying lengths of upper root portion 44. It can be seen that the supporting surface for the upper root portions that occurs at the boundary between the upper root portion 44 and lower locating pin 46 and indicated as sp on FIG. 5 is planar, whilst the upper surfaces of the upper root portions 44 defines the required curve of spee, labelled cs in FIG. 5.

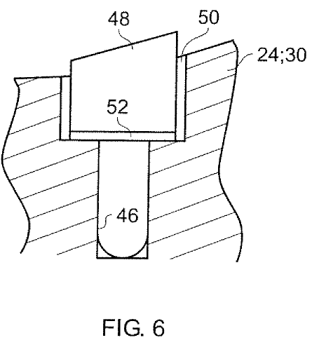

Healthy human teeth are able to deflect within the jaw by approximately 0.1 to 0.4 mm. To replicate this movement in some embodiments of the present invention the upper root portion 48 is slightly under dimensioned and a layer of resilient material 50 is bonded around the periphery of the upper root portion, the thickness of the resilient layer 50 being such that the required degree of deflection is provided when the teeth are subject to a mean mastication load. This is illustrated in FIG. 6, in which a tooth root according to an embodiment of the present invention is illustrated located within its corresponding cavity in the mandible 24 of maxilla 30. In the embodiment illustrated the lower locating pin 46 of the tooth root has a rounded base that also contributes to providing the required deflection of the tooth root during mastication. Also illustrated is a further resilient layer 52 that may optionally be provided to firstly also contribute to the desired deflection of the tooth root and secondly to provide a degree of compliance when the tooth is subject to a compressive force. This enhances the sensitivity of the axial sensor 42 (illustrated in FIG. 3) provided to sense the compressive forces being applied.

The dental simulator of the present invention is capable of simulating the wear of dental restorative material by controlling the simulator chewing motion to a high degree of accuracy than is provided by the known prior art apparatus.

1. Dental simulation apparatus comprising:
a six degrees of freedom motion actuator having an upper mobile portion; an artificial mandible secured to the mobile portion of the motion actuator, the artificial mandible being arranged to receive a plurality of artificial teeth or other dental restoratives; and
an artificial maxilla rigidly located about the artificial mandible, the artificial maxilla also being arranged to receive a plurality of artificial teeth or other dental restoratives.

2. The apparatus of claim 1, wherein a compliance module is located between the artificial mandible and the mobile portion of the motion actuator, the compliance module including at least one compressible portion arranged such that compression of the compressible portion results in a decrease in the separation of the artificial mandible ant the mobile portion of the motion actuator.

3. The apparatus of claim 2, wherein the compressible portion of the compliance module is arranged to be compressed only when a force in excess of a first threshold value is applied.

4. The apparatus of claim 2, wherein the compliance module comprises an upper plate connected to the artificial mandible and a lower plate connected to the mobile portion of the motion actuator, the upper and lower plates being spaced apart by at least one compressive spring mounted therebetween.

5. The apparatus of claim 1, wherein a force sensor is located between the artificial mandible and the mobile portion of the motion actuator, the force sensor being arranged to measure the compressive force applied to the artificial mandible.

6. The apparatus off claim 5, wherein the force sensor is further arranged to measure lateral forces applied to the artificial mandible.

7. The apparatus of claim 1, wherein the motion actuator comprises a static portion and a plurality of linear actuators connected between the static and upper mobile portions.

8. The apparatus of claim 7, wherein the apparatus further comprises a control module arranged to control the position, speed and applied force of the linear actuators.

9. The apparatus of claim 8, wherein each linear actuator includes a position encoder and is arranged to provide one or more encoder signals to the control module indicative of the position of the linear actuator, wherein the control module is arranged to process the encoder signals so as to provide closed loop control of the linear actuators.

10. The apparatus of claim 9, wherein the control module is further arranged to receive on or more signals indicative of the force applied by the actuators.

11. The apparatus of claim 1, further comprising a plurality of artificial teeth arranged to be located in either the artificial mandible or maxilla, each tooth having a root comprising a profiled upper root portion and a locating pin.

12. The apparatus of claim 11, wherein the profile of each upper root portion is different from the remaining teeth and the artificial mandible and maxilla includes a plurality of root receiving cavities, each root receiving cavity having a profiled section having a profile that is complementary to only one of the upper root portions, such that each tooth may only be located in a single cavity.

13. The apparatus according to claim 12, wherein each upper root portion has an upper planar surface for a dental crown to be secured to.

14. The apparatus according to claim 12, wherein the length of the upper root portions varies from tooth to tooth such that when each tooth is located in the corresponding cavity of the artificial mandible or maxilla, the upper surfaces of the upper root portions define a Curve of Spee.

15. The apparatus of claim 11, wherein the upper root portion includes an outer layer of resilient material.

16. The apparatus of claim 11, wherein the root includes a layer of resilient material interposed between the upper root portion and the locating pin.

17. The apparatus of claim 11, wherein the locating pin has a rounded end.
